(19) United States
(12) Patent Application Publication
(10) Pub. No.: US 2014/0196377 A1
(43) Pub. Date: Jul. 17, 2014

(54) Screen Window for Garage Door

(71) Applicant: Carla Muto, Plainfield, IL (US)

(72) Inventor: Carla Muto, Plainfield, IL (US)

(21) Appl. No.: 13/768,836

(22) Filed: Feb. 15, 2013

(51) Int. Cl. E06B 9/52; E06B 9/00

(52) U.S. Cl. CPC E06B 9/52; E06B 9/00
USPC 49/465

(57) ABSTRACT

A sliding screen window for a garage door may be built into new garage doors or may be sold separately for installation on existing garage doors. The window would generally, but not necessarily, be installed on the top panel of a garage door. The screen panel may be oblong in shape or may feature a decorative pattern of screened and non-screened shapes. Behind the screen is a plurality of transparent or opaque sliding plates that may be moved aside to allow air to flow through the garage door.

### CROSS-REFERENCE TO RELATED APPLICATIONS

Not Applicable

### STATEMENT REGARDING FEDERALLY SPONSORED RESEARCH OR DEVELOPMENT

Not Applicable REFERENCE TO SEQUENCE LISTING, A TABLE, OR A COMPUTER PROGRAM

LISTING COMPACT DISK APPENDIX

Not Applicable

### BACKGROUND OF THE INVENTION

The invention relates in general to the field of building fixtures, and in particular to the field of windows for garage doors. Paneled garage doors are used in a wide variety of contexts in homes and commercial buildings, and generally for the entrance to spaces used for storing vehicles and other goods, and for conducting various forms of work. Frequently, it is desirable to allow air to flow into and out of these spaces, but problematic for the garage door to simply be left open. For example, a garage door owner may wish to leave a space concealed by a garage door unattended or may wish to prevent insects from entering the space as it is allowed to be aired out.

It is useful, therefore, to have a screened window available within a garage door. In such situations as above, the garage door owner may open the window and allow air to pass between the concealed space and the outside.

### SUMMARY OF THE INVENTION

Accordingly, the invention is directed to a sliding screen window for a garage door. The window may be built into new garage doors or may be sold separately for installation on existing garage doors. The window would generally, but not necessarily, be installed on the top panel of a garage door. The screen panel may be oblong in shape or may feature a decorative pattern of screened and non-screened shapes. Behind the screen is a plurality of transparent or opaque sliding plates that may be moved aside to allow air to flow through the garage door.

It is an object of the invention to provide a way to allow air to pass into a space concealed by a garage door without opening the garage door.

It is an object of the invention to provide a screen for preventing insects and debris from entering the space concealed by the garage door.

It is an object of the invention to allow natural light to enter a space concealed by a garage door without opening the garage door.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 shows a first basic embodiment of the invention as installed in a garage door.

FIG. 2 shows a second decorative embodiment of the invention as installed in a garage door.

FIG. 3 shows an expanded top view of a third embodiment of the invention.

FIG. 4 shows an expanded top view of a fourth embodiment of the invention.

FIG. 5 shows a side-angle view of a fifth embodiment of the invention.

FIG. 6 shows a side-angle view of a sixth embodiment of the invention.

### DETAILED DESCRIPTION OF THE INVENTION

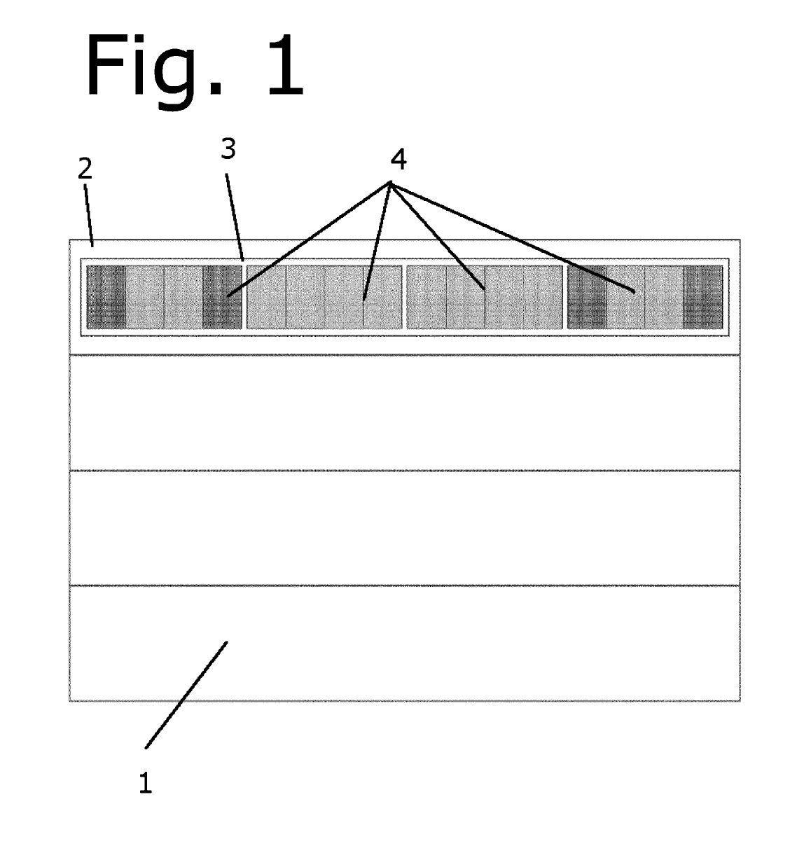

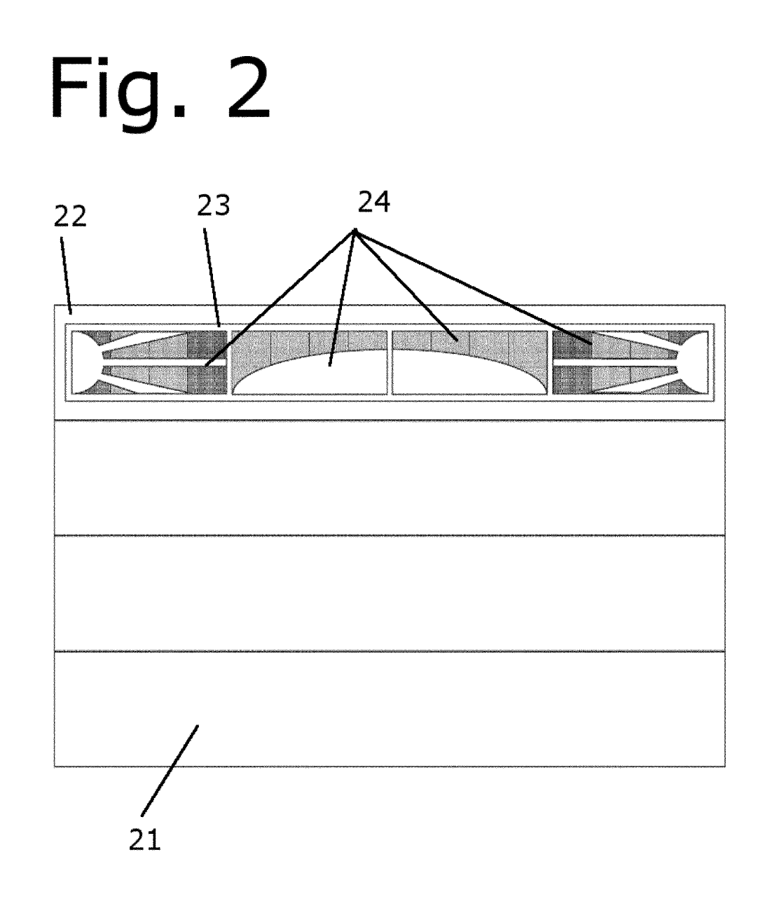

Referring now to the invention in more detail, FIGS. 1 and 2 show the basic concept of the invention as a screen window for a garage door as installed on the top panel of a garage door. FIG. 1 shows a basic first embodiment in which the garage door (1) on its top panel (2) features a window (3) with an outer screen layer (4). In the first embodiment, the screen portions are oblong in shape. FIG. 2 shows a more decorative second embodiment, again featuring a garage door (21) whose top panel (22) has been penetrated by a window (23), and the various sections of the window (23) are partly covered by screen (24) and partly by opaque material. Each window panel may be filled with one or more layers of screen material, transparent non-screen material, and opaque non-screen material. These layers may or not be able to slide horizontally or otherwise be opened to allow air to pass. Many suitable garage door materials and designs are known in the prior art; likewise may screen and non-screen window materials are known in the prior art and readily available (e.g. metal screens, glass windows). The window frame components may be made of wood, aluminum, vinyl, or other commonly available building materials.

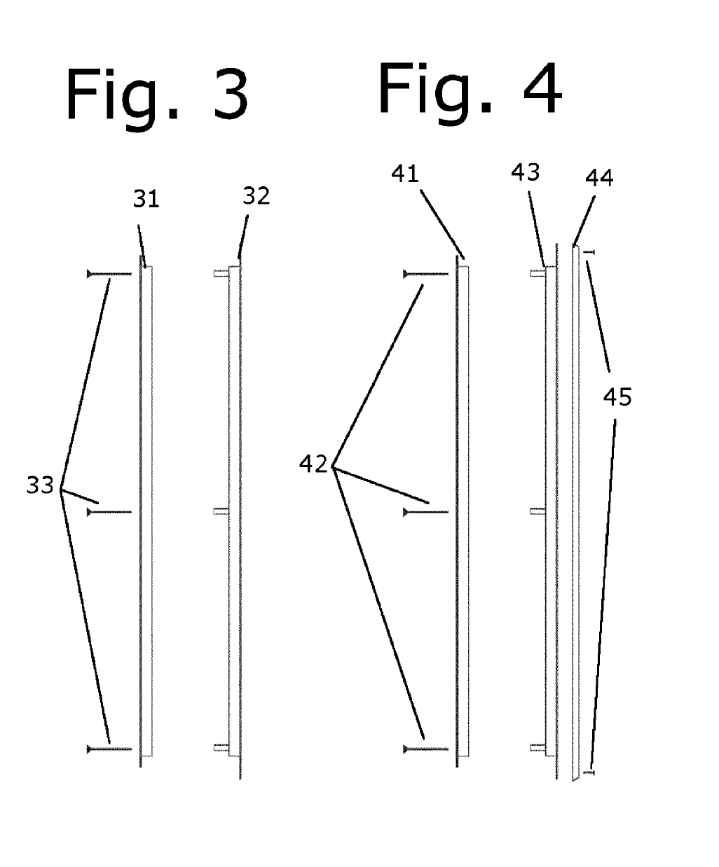

Turning now to the construction of the windows, FIG. 3 shows a third exemplary embodiment of the invention in expanded top view. In the third embodiment, an interior window frame (31) penetrates a hole in the garage door from the inside, while an exterior window frame (32) penetrates the garage door from the outside. The two couple together through the hole in the garage door and are fastened together by a fastener (33), which is shown as a screw, however many alternative fasteners are known in the prior art and may be used.

FIG. 4 shows a fourth exemplary embodiment in expanded top view. The fourth embodiment, like the third embodiment, features an interior window frame (41) and an exterior window frame (43), which couple through a hole in the garage door and are fasted by a set of fasteners (42), which may be screws or other types. In the fourth embodiment, an additional layer (44) is added to the exterior of the window. The additional layer (44) is fastened to the exterior window frame (43) by a set of fasteners (45), which may, but need not, be screws. Contrasting the third and fourth embodiments, in the third embodiment, all layers of window material (i.e. a screen, optional transparent material, and optional opaque material) must fit within a shallow depth determined by the window frame. However, in the fourth embodiment, one or more of such materials may be installed in the additional layer (45).

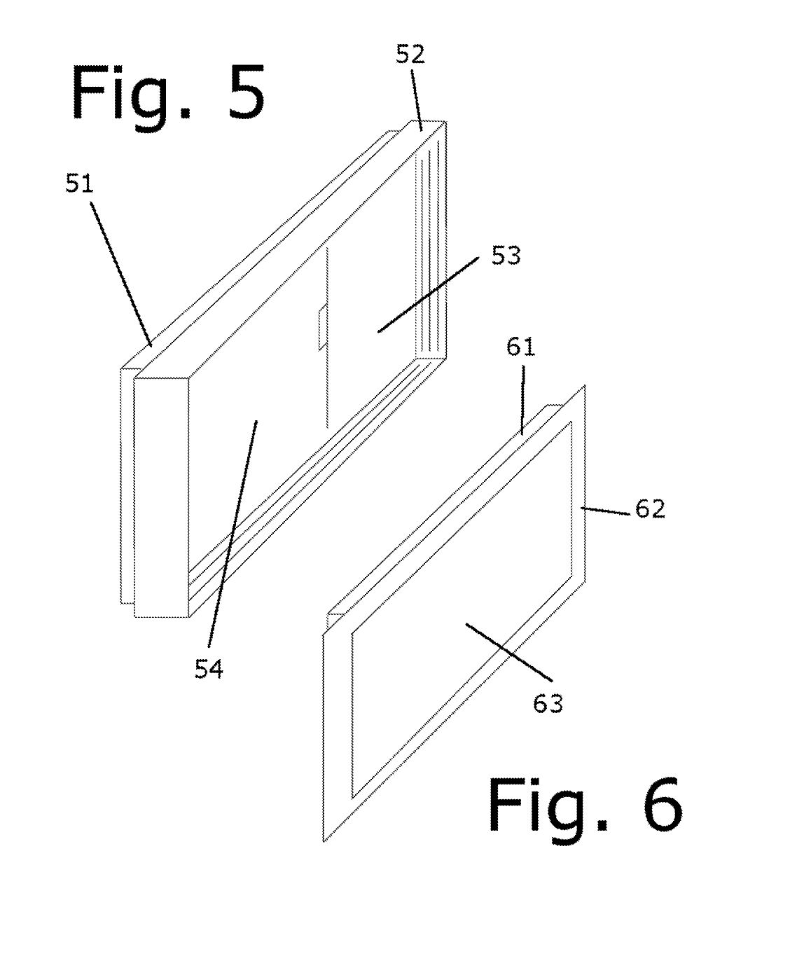

Turning now to the sliding configuration of the window, FIG. 5 shows a side angle view of a fifth exemplary embodiment of the invention. In the fifth embodiment, an interior frame (51) is coupled to an external frame (52) to create a housing with a plurality of sliding tracks for panels of material that fill the vertical space of the window frame and approximately half the horizontal space of the window frame. A first panel (53) and a second panel (54) are allowed to slide past each other when the user applies a manual force to one side or the other. The sliding panels may be screen panels, transparent panels, or opaque panels, and may be placed in front of or behind additional panels.

To compare, FIG. 6 shows a sixth embodiment of the invention featuring An interior frame (61) coupled through a hole in the garage door to an exterior frame (62) featuring an additional layer (63). The additional layer may be a screen panel concealing slidable or openable opaque panels.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A screen window comprising:
(a) a rigid panel substrate forming the top panel of a garage door;
(b) said rigid panel substrate having a rough opening;
(c) a first frame having a rigid perimeter and being substantially open in its center;
(d) said first frame being of a size and shape to conform to and fit snugly within said rough opening;
(e) a second frame having a rigid perimeter, and being substantially open in its center, and being a monolithic member separate from said first frame;
(f) said second frame being of a size and shape to conform to and fit snugly within the perimeter of said first frame;
(g) a first fastening means for fastening said first frame to said second frame such that said first and second frames are fixed to one another through said rough opening;
(h) said first frame and said second frame being affixed to one another by said first fastening means;
(i) a plurality of layers, each taken from any one the group of non-sliding screens, slidable screens, non-sliding sheets of rigid transparent materials, non-sliding sheets of rigid opaque material, slidable sheets of rigid transparent material, and slidable sheets of rigid transparent material;
(j) said plurality of layers being fixedly or slidably retained within said second frame; and
(k) each layer of said plurality of layers wholly or partially covering the inside area of said second frame, and at least one of said plurality of layers wholly covering the inside area of said second frame;
whereby light and ventilation are provided to an enclosed space located on the inside of said rigid panel substrate.

2. The screen window of claim 1 wherein said plurality of layers comprises a screen fixedly retained within said second frame such that said sheet of transparent material fully covers the inside area of said second frame.

3. The screen window of claim 1 wherein said plurality of layers comprises a sheet of transparent material fixedly mounted retained within said second frame such that said sheet of transparent material fully covers the inside area of said second frame.

4. The screen window of claim 2 wherein said plurality of layers further comprises a pair of sheets of transparent material slidably retained within said second frame, each of which covers about half of the inside area of said second frame.

5. The screen window of claim 4 wherein said plurality of layers further comprises an opaque layer fixedly mounted within said second frame and decoratively cut to cover less than the full inside area of said second frame.

6. The screen window of claim 1 wherein a third frame having a rigid perimeter and being substantially open in its center is provided, said third frame being of a size and shape substantially cover the exterior surface of said first frame or said second frame, and said third frame being fixedly attached to the exterior surface of said first frame or said second frame with a second fastening means for fastening said third frame to the exterior surface of said first frame or said second frame.

7. The screen window of claim 6 wherein a second plurality of layers taken from the group of non-sliding screens, slidable screens, non-sliding sheets of rigid transparent materials, non-sliding sheets of rigid opaque material, slidable sheets of rigid transparent material, and slidable sheets of rigid transparent material is provided, said second plurality of layers being fixedly or slidably retained within said third frame, and each layer of said second plurality of layers wholly or partially covering the inside area of said third frame.

8. The screen window of claim 7 wherein a greater set of layers is defined as including all of said plurality of layers and said second plurality of layers, and wherein said greater set of layers comprises a screen fixedly retained within said second frame or said third frame such that said sheet of transparent material fully covers the inside area of said second frame or said third frame.

9. The screen window of claim 8 wherein said greater set of layers further comprises a pair of sheets of transparent material slidably retained within said second frame or said third frame, each of which covers about half of the inside area of said second frame or said third frame.

10. The screen window of claim 9 wherein said greater set of layers further comprises an opaque layer fixedly mounted within said second frame or said third frame and decoratively cut to cover less than the full inside area of said second frame or said third frame.
